(19) United States
(12) Patent Application Publication
(10) Pub. No.: US 2026/0368260 A1
(43) Pub. Date: Nov. 19, 2026

(54) SYSTEM, METHOD AND COMPUTER-READABLE MEDIUM FOR DATA CORRELATION

(71) Applicant: AILY LABS GMBH, Munich (DE)

(72) Inventor: Bianca ANGHELINA, Munich (DE)

(73) Assignee: AILY LABS GMBH, Munich (DE)

(21) Appl. No.: 19/147,863

(22) PCT Filed: Jan. 13, 2023
(86) PCT No.: PCT/EP2023/050762

§ 371 Date: Jul. 14, 2025

(51) Int. Cl. G06F 16/906

(52) U.S. Cl. CPC G06F 16/906

(57) ABSTRACT

A system, corresponding method and computer-readable medium for data correlation, comprises a data foundation unit, a data correlator unit and a data visualization unit. The data correlator unit comprises a hidden feature extraction unit, a time-aware clustering unit, a correlation classification unit, and a real-time recommendation unit. The invention allows to adapt processes, for example manufacturing processes, supply management or production capacity in real-time based on correlations between key performance indicators.

### CROSS-REFERENCE TO RELATED APPLICATIONS

This application is a U.S. National Phase of PCT Application No. PCT/EP2023/050762 filed Jan. 13, 2023, the disclosure of which is hereby incorporated in its entirety by reference herein.

### TECHNICAL FIELD

This disclosure relates to faster digital processing. In particular, the invention relates to processing large amounts of uncorrelated or correlated data and how to move from static information such as fragmented reports, disconnected data, or long planning cycles to real-time interaction. This, therefore, allows, by using artificial intelligence (AI), to provide real-time scenarios based on AI insights. This disclosure further allows to optimize processes and operations based on AI powered decisions.

### BACKGROUND

Decisions related to present day manufacturing processes are often too complex and challenging for the human brain. There are billions of decisions per manufacturing cycle to be made, whereby the correlation between the decision effectiveness and the performance of the decision within a process plays an important role. The problem that decisions are too complex to be derived analytically also relates to the fields of customer relation management, financial decisions related to such processes, and research and development processes.

### SUMMARY

Artificial intelligence (AI) and machine learning may generate insightful recommendations to optimize processes and respective decisions. This disclosure relates to a holistic approach to recommend most impactful decisions based on raw data, which have been cleaned and transformed with the help of AI.

This disclosure relates to deriving decisions with respect to key performance indicators. Key performance indicators may be, for example, inventory of goods at distribution centers, inventory of goods at manufacturing sites, overall equipment efficiency, machine capacity utilization, forecasted units of out of stock supply, past units of out of stock supply, QA deviations of manufacturing process, batches affected by deviations, variability of manufacturing processes, manufacturing yield, N^{o} of manufacturing sites, N^{o} of sites for clinical trials, raw material supplier invoices. This allows to optimize production processes by optimizing the respective parameters.

This disclosure allows to gain insight into correlations between large amounts of distributed data. In particular, this disclosure allows to gain insight into the correlation between key performance indicators derived from distributed data allowing the user to act in real-time on one or more recommendations derived from the correlations. Therefore, this disclosure allows to move from static data to real-time interactions allowing the user to adapt processes in accordance with the determined correlations between key performance indicators. By using distributed data, which may be distributed over several unrelated systems, the data can be correlated across different systems to increase speed and efficiency.

This disclosure allows to adapt processes, for example, manufacturing processes, supply management or production capacity in real-time based on correlations between key performance indicators, for example, decision effectiveness and financial performance, plant efficiency and supply, supply and demand, out of stock supply and demand, capacity utilization, or the ratio of complaints. Based on the correlations the invention allows to optimize the underlying processes and to avoid situations in which, for example, plant capacity is not effectively utilized or in which production has to stop due to lack of supply of raw materials. Lack of supply of raw materials may lead to out of stock risk of not being able to supply customers because of production issues caused by the lack of supply. Thus, this disclosure allows to optimize processes or to make processes more efficient.

The invention and the relevant parameters are not limited to production processes. The invention may also be used to optimize and adapt research and development, finance, or customer relation management processes.

By determining the correlation between key performance indicators, the user is provided with decisions based on which the user acts and adapts the process. For example, by optimizing a production or development process based on a recommendation.

As an example, the correlation between demand and energy consumption of a production process may lead to the recommendation to decrease the production output to save energy due to less demand. Without such recommendation, the manufacturing plant may have operated on maximum capacity consuming a high amount of energy until the demand would have stopped.

This disclosure, thus, allows to forecast the expected amount or value of an indicator based on correlation(s) and to provide a recommendation in anticipation of the demand, whereby the recommendation allows to optimize the process with respect to energy consumption. The skilled person understands that the above is only one of many example scenarios, which allow to optimize a process based on a recommendation which is based on the correlation of key performance indicators. In particular, although the example refers to demand and energy consumption as key performance indicators, any indicator can be used for the invention.

This disclosure therefore relates to the problem of correlating data from different sources to allow optimization with respect to key performance indicators.

The problem is solved by a system for data correlation, wherein the system comprises a data foundation unit comprising an input interface, wherein the input interface is configured to receive data from at least one data source, wherein the data foundation unit is configured to format the data as raw input data for further processing, wherein the system further comprises a data correlator unit, wherein the data correlator comprises a hidden feature extraction unit configured to transform the raw input data for hidden feature extraction and to extract hidden features based on the transformation and to output the result of the hidden feature extraction, a time-aware clustering unit configured to determine the time-evolution of an indicator, wherein the indicator is associated with the output of the hidden feature extraction and wherein the time-aware clustering unit is configured to compute a value associated with the similarity of two indicators based on the time-evolution of the indicators and to sort the indicators into groups based on the value by using artificial intelligence and to compute pairwise correlations between the indicators within each group, wherein the system further comprises a correlation classification unit configured to classify the correlations, a real-time recommendation unit configured to output a list of recommendations based on the classification of the correlations, and a data visualization unit comprising an output interface and configured to output the list of recommendations.

The input interface may be configured to be most agnostic to the underlying data. The interface therefore may be configured to process any type of data. For example, the input interface may process excel files or css files. The input interface may receive input from any type of data source. The data source can be a database. There may be one or more data sources. A database may be connected to the interface, for example, wireless. The database may be connected to the interface via a public network, for example the Internet. For example, the database may be a redshift database or files in an Amazon S3 bucket.

The input interface may be associated to one or more clients. The clients may be mobile devices. The clients may be part of a computing infrastructure or connected to a computing infrastructure. The computing infrastructure may be a cloud-based system. The computing infrastructure may comprise only one device or more than one device. The input interface may be configured for each specific client. The input interface may be configured using one or more configuration files. Each client device may be connected to a different database or system providing input data.

The configuration files may specify key performance indicators (KPIs) that are related and where correlations are expected. As such, the inputs of the interface are configured for formatting and collection from the respective sources. In particular, the interface is configured using one or more configuration files.

The one or more configuration files may include the key performance indicators, the pairwise correlation between the key performance indicators, and the data from which the key performance indicators are derived. Further, the one or more configuration files may include filters for processing the data or the key performance indicators. The configuration files may include a timestamp or a parameter, which specifies which data should be used. In one embodiment, only data starting from a particular date should be used to derive the key performance indicators. For example, only data from the year 2020 onwards should be used by the system.

In another example, the configuration files may specify a minimum time frame for which correlations are extracted. For example, the configuration files may specify a minimum number of months for which correlations are extracted. In one embodiment, the minimum number of months is 12 so that meaningful correlations can be extracted for that time period. In another embodiment, the one or more configuration files may specify a time frame.

In one embodiment, there is a cloud data infrastructure that performs computations. The cloud infrastructure may provide the results of the computations to one or more client devices. The client devices may run an application or web interface to visualize the results to a user. The results may be a recommendation that prompts the user to perform an action. There may be additional one or more client devices connected to the cloud data infrastructure that allow configuration of the cloud data infrastructure and the computations performed by the cloud data infrastructure. The additional one or more client devices may be configuration client devices. The configuration client devices allow for configuration of the system, in particular, for the configuration of the correlation solution, the user of the configuration client devices may be allowed to provide input with respect to the particular application of the data correlation system.

The data correlation system may be configured with respect to the data input. The data input may be determined by the particular application or by the needs of a user of the data correlation system. The configuration of the data correlation system may also comprise the key performance indicators. The data correlation system may be configured by the one or more client devices by using one or more configuration files. The key performance indicators may be selected or configured with respect to the particular application or the user's needs. There may be one or more input client devices that are connected to the cloud data infrastructure to allow data input from several distinct sources. The sources may be any kind of datasource, for example, database or cloud based systems or databases.

In one embodiment, a user or implementer may use an input interface to provide configuration data via a configuration input device, wherein the configuration data include key performance indicators and information on the data as discussed above. The configuration data may be provided in the form of one or more configuration files.

For example, the data foundation unit is configured to format the input data for further processing into raw input data. The data foundation unit may format the input data into raw time series. The raw data time series may correspond to the values of a key performance indicator associated with time values. In other words, the input data may correspond to one or more data associated with a key performance indicator or the raw input data may be values of a key performance indicator including the time at which the value occurred or at which the value was measured or stored. The data foundation unit may sort the values of the key performance indicator by time. For example, the data foundation unit may generate tuples of the value of the key performance indicator and the respective time value. In another example, a raw time series may be the values of a key performance indicator delimited by commas or other suitable delimiters. Between each value delimited by a delimiter may be a distinct time step. The time step may have the same value between each of the values delimited by the delimiter.

The raw input data may be raw time series. The raw data time series may be the values of a key performance indicator. In particular, the raw data time series may be the values of a key performance indicator with respect to time. The hidden feature extraction unit may decompose the raw input data in trend, seasonality, residuals, perceptual change, standardized values, flag outliers and assess the heterostadicity of the raw input data. An outlier is a point within a time series that is very far away from its normal value. For example, in case of a series of monthly inventory with values that range from 200 to 500: If suddenly a value of 1000 (double the normal maximum) would occur, this occurrence would be considered an outlier. The outlier can be defined in terms of standard deviation or inter-quartilic-range (IQR). For example, a value that deviates more than 3 times the standard deviation of the considered time series would be considered as an outlier. In other examples, a value deviating more than 1, 2, 3, 4, or 5 times the standard deviation would be considered an outlier. For example, an outlier may also be defined in terms of Interquartile range. A value may be considered an outlier in case it has a distance of 1, 2, 3, 4, or 5 times the interquartile range from the average value.

The input of the time-aware clustering unit preferentially is the output of the hidden feature extraction unit. The input of the time-aware clustering unit may be the results of the hidden feature extraction. The output of the hidden features extraction may be the time series and all their components, e.g., raw, seasonality time series, trend time, residual time series, percentual changes of the time series, and outliers within the time series. A comparison is done only between the same categories of data types, e.g. raw with raw, season with season residual with residual. In order to compare the same categories of data types, various metrics are computed to determine the similarity. For example, dynamic time warping (DTW), cross-lagged correlation, piecewise aggregate approximation (PAA), or symbolic aggregate approximation (SAX) are used.

The time-aware clustering unit determines the time-evolution of an indicator, wherein the indicator is associated with the output of the hidden feature extraction. For example, the time evolution of the similarity between indicators is derived/determined using dynamic time warping.

The time-aware clustering unit computes a value associated with the similarity of two indicators based on the time-evolution of the indicators. The similarity may be computed with various metrics. For example, first the distance and the normalized distance from dynamic time warping is computed. Assessing the similarity on all of these different axes allows to have a more precise outlook into how related the indicators are. The indicators may be key performance indicators (KPI).

The time-aware clustering unit computes the similarity between pairs of indicators. One indictor may be compared to multiple ones. For example, out-of-stock (OOS) can be compared to demand data for that same product and also to manufacturing deviations for that same product. The time-aware clustering unit sorts the indicators into groups for which pairwise correlation between the indicators is computed. The output of the time-aware clustering unit may be similarity. For example, the result of the distance and the normalized distance from dynamic time warping, the result of cross-lagged correlation or standard Pearson correlation, whereby the particular result is the value for the similarity.

The correlation classification unit is configured to classify correlations. The input of the correlation classification unit may be a table of pairwise relationships between indicators with their raw distances from DTW, distances from DTW, correlation from Pearson and cross-lagged correlation, length of the time series.

The correlation classification unit computes quartiles and ranks the correlations from the input to extract recommendations. For example, for time series that are highly correlated on any axis, the correlation classification unit may apply causality methods, such as Granger Methods or Double Machine learning, and finally extract the recommendations from there, depending on the found correlation and/or causality and/or lag.

The real-time recommendation unit is configured to output a list of one or more recommendations, wherein the recommendations are based on the classifications of the correlations. The classification of recommendations may be received from the correlation classification unit. In particular, a recommendation may be based on one or more specific scenarios using predefined rules. The scenario may comprise predefined correlations, lag, or values for key performance indicators. Machine learning can be used to generate output in form of instructions to a user or a machine based on the recommendation.

For example, a scenario may assume a specific relationship between for two indicators, which may be for example out of stock supply and the Sales. A scenario may define a particular level of correlation to which the scenario applies. For examples, the absolute value of the correlation must be above 70% or 0.7. In other examples, the correlation must be above 0.75, 0.8, 0.85, or 0.9. The scenario may also define an amount of lag between the two indicators.

In one example, the correlation between the number of sales and out of stock supply may be 80% and the threshold for the scenario may be 70% or 0.7. The indicators may also be highly negatively correlated, e.g. the value of the correlation may be −0.8 for instance for number of sales and number of stock. The lag between the two indicators may be a particular amount of time or number of values. Thus, the time evolution of a supply indicator may be for example anti proportional to the number of sales and time shifted by the lag. In this example, a demand peek, which is a high number of sales, is followed by an out of stock supply event. The scenario therefore defines that in case the two indicators number of sales and out of stock supply are correlated more than 0.7 a demand peek causes an out of stock supply event due to the negative correlation between the two indicators. Further, the out of stock event may occur with a particular amount of lag, which has been determined between the time evolution of the two indicators. The recommendation which is defined for this scenario therefore may be to increase the supply to avoid the out of stock event when a peek in demand or a high amount of sales occur. In other words, the data correlator determines whether the scenario applies for the indicators in question and then outputs the defined recommendation for this scenario. The recommendation for such a scenario may be determined by using machine learning to determine the measures to be taken and the output to the user.

For example, in case key performance indicators are correlated, it is derived based on the correlation how a change in one of the key performance indicators affects the other key performance indicator. For example, if the first indicator decreases the second indicator may increase. The correlation, therefore, allows to anticipate the behaviour of one indicator based on the other indicator. Thus, in case one of the indicators shall maintain particular values or to change towards a particular value this change can be achieved by adjusting the other indicator. For example, in case one indicator should be in a predetermined range of values the real-time recommendation unit may provide a recommendation for values of the other key performance indicator. For example, there may be high demand for a product and the demand is correlated with the inventory of a manufacturing plant. As the inventory may be related to the supply, the supply to serve the demand can be anticipated and the input of supply to the manufacturing plant can be adapted accordingly. Thus, the recommendation would be to change the supply as determined by the real-time recommendation unit based on the correlation between the key performance indicators demand and inventory as also described in the context of the description of scenarios above.

The recommendations may be derived by the real-time recommendation unit based on the classification of the correlations and the possible causality and time lag, which may be determined by using Granger methods or double-machine learning, and on the type of indicators for which that relationship has been found. For example, the Granger causality test is a statistical hypothesis test for determining whether one time series is useful in forecasting another. Therefore, in another example, the values of one times series, which may correspond to a key performance indicator, may be used to forecast or anticipate the other time series or key performance indicator.

In an embodiment, the data visualization unit is further configured to initialize actions associated with the recommendations. The data visualization unit may be executed on a client device. The client device may be a user device or an end device. The data visualization unit may be an application (APP) executed on a client device. The client device may be a mobile device such as a smartphone, tablet, laptop computer or the like. The client device may run an application or web interface to display the recommendations. In particular, the data visualization unit may be an application or web interface to display the recommendations to a user via an output interface of the client device. The client device may be connected to the system for data correlation. The connection may be wireless. The connection may be a connection via the Internet.

In one embodiment, the hidden feature extraction unit is configured to decompose the raw input data in trend, seasonality, residuals, or perceptual change.

In another embodiment, the hidden feature extraction is using auto-regressive seasonal extraction. Auto-regressive seasonal extraction may decompose the input into three items that complement the raw time series: seasonality, trend, and residuals.

In yet another embodiment, the time-aware clustering unit is using dynamic time-warping (DTW), cross-lagged correlation, piecewise aggregate approximation (PAA), or symbolic aggregate approximation (SAX) to determine the value associated with the similarity of the indicators.

In further embodiment, wherein the correlation classification unit is using a K-means or neural networks to classify correlations between the indicators. The correlation classification unit utilizes self-organizing maps.

In one embodiment, the real-time classification unit is using collaborative filtering or Markov models to create the list of recommendations.

In another embodiment the units of the system may be executed on different or the same device(s).

In yet another embodiment, the correlation classification unit determines the recommendations based on a scenario.

In a further embodiment, a scenario defines a threshold for the correlation of two indicators, wherein the scenario further defines recommendation for the two indicators based on the type of indicator and the amount of correlation.

In another embodiment the scenario further includes an amount of lag between the two indicators.

### BRIEF DESCRIPTION OF THE DRAWINGS

FIG. 1 schematically and as an example shows a flow diagram of the process of the invention.

FIG. 2 schematically and as an example shows the time evolution of two correlated indicators.

### DETAILED DESCRIPTION

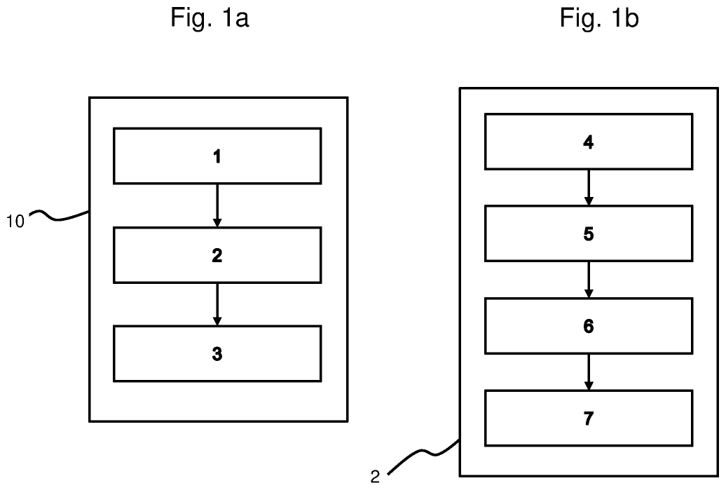

FIG. 1a shows a schematic overview of a data correlation system 10. The system 10 includes a data foundation unit 1, a data correlator unit 2, and a data visualization unit 3. The data foundation unit 1 formats raw data, which may be requested or received from many different data sources into raw time series with respect to one or more key performance indicators. The selected data sources and the indicators may be configured and/or selected by a user, for example via a configuration client device connected to the data correlation system 10. The formatted one or more raw time series are forwarded to the data correlator unit 2.

FIG. 1b shows the data correlator unit 2, which includes a hidden feature extraction unit 4, a time-aware clustering unit 5, a correlation classification unit 6, and a real-time recommendation unit 7.

The data correlator unit 2 includes the hidden feature extraction unit 4 as shown in FIG. 1b. The hidden feature extraction unit 4 may decompose the one or more raw time series input in trend, seasonality, residuals, perceptual change, standardized values, flag outliers and assess the heterostadicity.

The one or more decomposed time series are forwarded to the time-aware clustering unit 5. In particular, the components of the time series with respect to seasonality, trend, residual, percentual changes and outliers are forwarded to the time-aware clustering unit 5. The time-aware clustering unit 5 determines the time-evolution of an indicator based on the time series associated with this indicator. For example, the time-aware clustering unit 5 utilizes dynamic time warping. The time-aware clustering unit 5 determines the similarity between two indicators.

The similarity is determined by dynamic time-warping, cross-lagged correlation, piecewise aggregate approximation (PAA), or symbolic aggregate approximation (SAX). An output of the time-aware clustering may be the similarity between a pair of indicators. For example, the similarity may be the result of the distance and the normalized distance from dynamic time warping, the result of cross-lagged correlation or standard between the two indicators of the pair of indicators or Pearson correlation.

The time-aware clustering unit 5 generates a table of pairwise relationships between indicators with their raw distances from DTW, distances from DTW, correlation from Pearson and cross-lagged correlation, piecewise aggregation approximation, SAX distance, and length of the time series. The results of the time-aware clustering unit 5 are forwarded to the correlation classification unit 6.

The correlation classification unit 6 is configured to classify the correlations. The input of the correlation classification unit 6 may be a table of pairwise relationships between indicators with their raw distances from DTW, distances from DTW, correlation from Pearson and cross-lagged correlation, piecewise aggregation approximation, SAX distance, and length of the time series.

The correlation classification unit 6 computes quartiles and ranks the correlations from the input to extract recommendations. For example, for time series that are highly correlated on any axes, the correlation classification unit may apply causality methods, such as Granger or Double Machine learning, and finally extract the recommendations from there. The output of the correlation classification unit 6 is forwarded to the real-time classification unit 7.

The real-time classification unit 7 outputs a list of recommendations. The list may only contain one recommendation or no recommendation. For example, in case of two correlated indicators the correlation classification unit 6 applies the Granger causality test whether one time series is useful in forecasting another. Therefore, the values of one time series, which may correspond to a key performance indicator, may be used to forecast or anticipate the other time series or key performance indicator. The real-time classification unit 7 forwards the recommendations to the data visualization unit 3.

For example, in case of two correlated indicators the correlation classification unit 6 may forecast the development of the indicators based on the correlation.

The real-time classification unit 7 may then provide the recommendation in form of correlation graphs and/or textual information for pairs of indicators.

The data visualization unit 3 may be run as an application or a web interface on a client device. The client device may be a mobile device. The app may provide the recommendation or the recommendations as visual output via an output interface, which may be a display. The recommendation may be to increase or decrease one of the indicators to keep the other indicator in a range of values or at a particular value. In particular, a recommendation may be based on one or more specific scenarios using predefined rules. A scenario may comprise predefined correlations, lag, or values for key performance indicators as described.

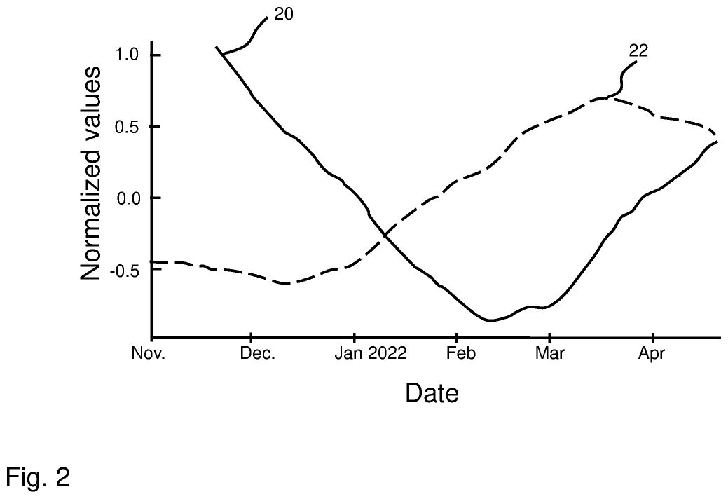

FIG. 2 shows the output of the visualization unit run as an app or web interface on a client device with respect to an example embodiment of the invention. The input data corresponds to the capacity or dosage of an active agent 20 and a ratio of complaints 22 associated with the usage of the active agent. Alternatively, the input data may also include a usage of a manufacturing site, origin of resources such as energy or the like. The data may comprise many other values.

The data correlator unit 2 formats the raw data into raw time series in accordance with key performance indicators that may be selected by a user, for example the capacity or dosage of an active agent and a ratio of complaints associated with the usage of the active agent. The data foundation unit outputs the raw time series of the one or more key performance indicators and provides the output to the data correlator unit. In FIG. 2, the normalized data is illustrated over time as graphs for the capacity of dosage of the active agent 20 and the ratio of complaints 22.

The data correlator unit then correlates the data as described with respect to FIG. 2.

In the present example, after the data correlator has correlated the indicators with respect to the capacity of the active agent and the ratio of complaints, the correlation is determined to be 0.87, i.e., a high negative correlation. As can be seen from the graphs 20, 22, the corresponding relation is anti-proportional, but time shifted about two months. In other words, a decrease in capacity leads to an increase in the ratio of complaints but delayed about a time of two month. This allows to forecast the development of one indicator with respect to the development of the other.

FIG. 2 shows the visualized output of the client device on which the data visualization unit 3 in form of an application or web interface runs. From the results of the correlation classification unit 6, the real-time recommendation unit 7 has derived that diminishing the capacity utilization of the active agent leads to an increase in the number of complaints. Therefore, the user would adjust the capacity utilization to higher values to avoid a high number of complaints. As can be understood from this example, the invention allows not only to determine correlations between indicators or data series, but also provides one or more recommendations based on the analysis of the data that yields actions to be performed in order to achieve certain goals or keep processes in optimal parameter range.

1. A system for data correlation, comprising:
a data foundation unit including an input interface, wherein the input interface is configured to receive raw input data from at least one data source, wherein the data foundation unit is configured to format the raw input data for further processing;
data correlator unit including:
a hidden feature extraction unit configured to transform the formatted raw input data for hidden feature extraction and to extract hidden features based on the transformation and to output the result of the hidden feature extraction,
a time-aware clustering unit configured to determine the time-evolution of an indicator, wherein the indicator is associated with the output of the hidden feature extraction, wherein the time-aware clustering unit is configured to (i) compute a value associated with the similarity of two indicators based on the time-evolution of the indicators, (ii) to sort the indicators into groups based on these values by using artificial, and (iii) to compute pairwise correlations between the indicators within each group;
a correlation classification unit configured to classify the correlations;
a real-time recommendation unit configured to output a list of recommendations based on the classification of the correlations; and
data visualization unit comprising an output interface and configured to output the list of recommendations.

2. The system of claim 1, wherein the data visualization unit is further configured to initialize actions associated with the recommendations.

3. The system of claim 1, wherein the hidden feature extraction unit is configured to decompose the formatted raw input data in trend, seasonality, residuals, or perceptual change.

4. The system of claim 1, wherein the hidden feature extraction unit is using auto-regressive seasonal extraction.

5. The system of claim 1, wherein the time-aware clustering unit is using dynamic time-warping (DTW), cross-lagged correlation, piecewise aggregate approximation (PAA), or symbolic aggregate approximation (SAX) to determine the value associated with the similarity of the indicators.

6. The system claim 1, wherein the correlation classification unit is using a K-means neural network to classify correlations between the indicators.

7. The system of claim 1, wherein the real-time classification unit is using collaborative filtering or Markov models to create the list of recommendations.

8. The system of claim 1, wherein the correlation classification unit determines the recommendations based on a scenario.

9. The system of claim 8, wherein a scenario defines a threshold for the correlation of two indicators, wherein the scenario further defines a recommendation for the two indicators based on the type of indicator and the amount of correlation.

10. The system of claim 9, wherein the scenario further includes an amount of lag between the two indicators.

11. A method for data correlation, wherein in the method comprises:
receiving, by a data foundation unit comprising an input interface, raw input data from at least one data source;
formatting, by the data foundation unit, the raw input data for further processing;
transforming, by a hidden feature extraction unit of a data correlator unit, the formatted raw input data for hidden feature extraction and extracting hidden features based on the transformation and outputting the result of the hidden feature extraction;
determining, by a time-aware clustering unit of the data correlator unit, the time-evolution of an indicator, wherein the indicator is associated with the output of the hidden feature extraction;
computing, by the time-aware clustering unit, a value associated with the similarity of two indicators based on the time-evolution of the indicators;
sorting, by the time-aware clustering unit, the indicators into groups based on the value by using artificial intelligence;
computing, by the time-aware clustering unit, pairwise correlations between the indicators within each group;
classifying the correlations by a correlation classification unit;
outputting, by a real-time recommendation unit, a list of recommendations based on the classification of the correlations;
outputting, by a data visualization unit comprising an output interface, the list of recommendations.

12. The method of claim 11, wherein the method further comprises decomposing, by the hidden feature extraction unit, the raw input data in trend, seasonality, residuals, or perceptual change.

13. The method of claim 11, wherein the step of extracting hidden features further comprises using auto-regressive seasonal extraction.

14. The method of claim 11, wherein the step of computing a value associated with the similarity of two indicators further uses dynamic time-warping (DTW), cross-lagged correlation, piecewise aggregate approximation (PAA), or symbolic aggregate approximation (SAX) to determine the value associated with the similarity of the indicators.

15. A computer-readable medium comprising instructions which, when executed by a processor, cause one or more processors to carry out the method of claim 11.
